(19) United States
(12) Patent Application Publication
(10) Pub. No.: US 2007/0101422 A1
(43) Pub. Date: May 3, 2007

(54) Automated network blocking method and system

(76) Inventor: Michael A. Carpenter, Raleigh, NC (US)

Correspondence Address: Robert A. Voigt, Jr.;WINSTEAD SECHREST & MINICK PC, PO BOX 50784, DALLAS, TX, 75201, US

(21) Appl. No.: 11/263,039

(22) Filed: Oct. 31, 2005

(51) Int. Cl. G06F 15/16; G06F 15/173; G06F 17/00; G06F 9/00

(52) U.S. Cl. 726/13; 726/14; 709/224

(57) ABSTRACT

A method and system for logically disconnecting a host computer from a network and for reconnecting it in the same manner, such that physical rewiring is not required. The method and system provides security during a virus attack by rapidly isolating an affected host, thereby preventing attack propagation. Logical connections are managed using a network filter to suspend all traffic from a given network host. The network filtering may be implemented as a network protocol or as an administrative tool from a network server.

### TECHNICAL FIELD

The present invention relates in general to computer network security systems, and in particular, to controlling network connectivity.

### BACKGROUND INFORMATION

Computer security and network security are very important today for preventing attacks by others, particularly when the computer and network are connected to the Internet or another untrusted network. These attacks can be in the form of computer viruses, worms, denial of service, improper access to data or other kinds of malicious software, generally referred to as viruses. Communications network security, generally, and computer network security in particular, are frequently the objects of sophisticated attacks by unauthorized intruders, including hackers. Intruders to such networks are increasingly skilled at exploiting network weaknesses to gain access and unauthorized privileges, making it difficult to detect and trace such attacks. Moreover, security threats from malicious software, such as viruses and worms, may propagate without human supervision and are capable of replicating and traveling to other networked systems. Such intrusions can damage computer systems and adversely affect vital interests of entities associated with the affected network.

In particular, the propagation of malicious software within a network can cause the damage to increase exponentially in a short time. The adverse effects of a virus attack on a computer network can cause incapacitation of client computers, network infrastructure, and network servers. This can result in a shutdown of business-critical operations and large economic losses from downtime and lost productivity. The commercial damage inflicted by virus attacks includes all efforts required to contain the malicious software and extensive labor resources required to perform repairs and restoration. Therefore, prevention of attacks and containment of damage are critical aspects to network security.

Traditionally, network security has concentrated on setting up a perimeter to keep unauthorized people out. Modem commercial information security requires a focus on enabling business and creating a perimeter that can grant access to employees, customers, suppliers, and authorized parties. Once perimeter network security is breached, further security measures include various kinds of virus protection systems on the network clients and at other access points, such as webservers. Further security measures may involve network topology, such as the erection of a firewall. Unfortunately, virus protection remains inherently fallible to some degree. Therefore, a proactive approach to preventing damage includes identifying host machines that have become infected as well as those that are unprotected and remain vulnerable to attacks. Once an attack is suspected, the first step in remediating a catastrophic outbreak is getting the infected hosts isolated from the network. Isolation of network hosts is necessary to prevent further spreading of the attacking, malicious software, which is generally designed to take control of network hosts and use them for further attacks. Isolating a network host can be as simple as disconnecting the network cable, thereby eliminating the possibility of further communication with other hosts, which in turn, breaks the propagation chain of the attack. This solution, while simple, requires an administrator to locate the machine, physically disconnect it, and then reconnect it upon remediation. For large scale networks, with hundreds and thousands of clients, physical disconnection is both impractical and slow, and thus, represents an ineffective method of isolating network hosts during a virus attack.

As a result of the foregoing, there is a need for providing a rapid, automatic method for managing the connectivity of host computers connected to a network.

### SUMMARY OF THE INVENTION

The present invention addresses the foregoing need by providing a method and system for logically disconnecting a host computer from a network and for reconnecting it in the same manner. The term logical disconnection refers to the notion of instructing the forwarding components of the network to disallow transmission by the host computer. In this manner, the host computer may maintain its physical connections with the network, but will no longer be able to propagate a virus attack, since any communication required to infect other host computers will be suspended. The logical disconnection may be performed in response to a command issued manually by an administrator or to a command triggered automatically in response to suspicious behavior exhibited by the host computer. A logical reconnection may be performed once network security has been reestablished and the host system has been remediated. A logical reconnection refers to the notion of instructing the forwarding components of the network to allow transmission by the host computer. An advantage of the present invention is the capability of automation, thereby requiring minimal effort and providing a timely response to a virus attack, i.e., before extensive damage has occurred. The present invention is a viable solution even if the network traffic to a large number of host computers need be suspended and later restored. One embodiment of the present invention may be implemented as a network protocol that sends commands to each network interface. Another embodiment of the present invention may be implemented as an administrative tool that may be executed on a network server.

An object of the present invention is to provide a means for suspending network traffic from a given physical address belonging to a network host by logically disconnecting the host from the network.

Another object of the present invention is to provide a means for resuming network traffic from a given physical address belonging to a network host by logically reconnecting the host from the network

A further object of the present invention is to provide a means for filtering network traffic from a given physical address by instructing network devices to block data packets for the given physical address.

Another object of the present invention is to provide a manual or automatic mechanism for logically disconnecting a network host from a network.

At least one of the preceding objects is met, in whole or in part, by the present invention. The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates the layers of an industry standard network interconnection reference model;

FIG. 2 illustrates a flow chart of an embodiment of the present invention;

FIGS. 3A and 3B illustrate flow charts of individual functions in one embodiment of the present invention;

FIG. 4 illustrates a typical network configuration in an embodiment of the present invention; and

FIG. 5 illustrates a typical system hardware configuration of a network host in an embodiment of the present invention.

### DETAILED DESCRIPTION

In the following description, numerous specific details are set forth such as specific word or byte lengths, etc. to provide a thorough understanding of the present invention. However, it will be obvious to those skilled in the art that the present invention may be practiced without such specific details. In other instances, well known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

For the purposes of localizing a host computer coupled to a given network, a physical address refers to a unique, hardware-dependent address or identification that is accessible from the network. A physical address generally does not change unless a hardware component coupled to the network host is replaced. In contrast, a network address is an address or identification that is assigned by a network protocol or administrator. A network address may generally be revoked or reassigned to another network host in the same manner that it is assigned. A network address may also contain information about the topology and organization of the network.

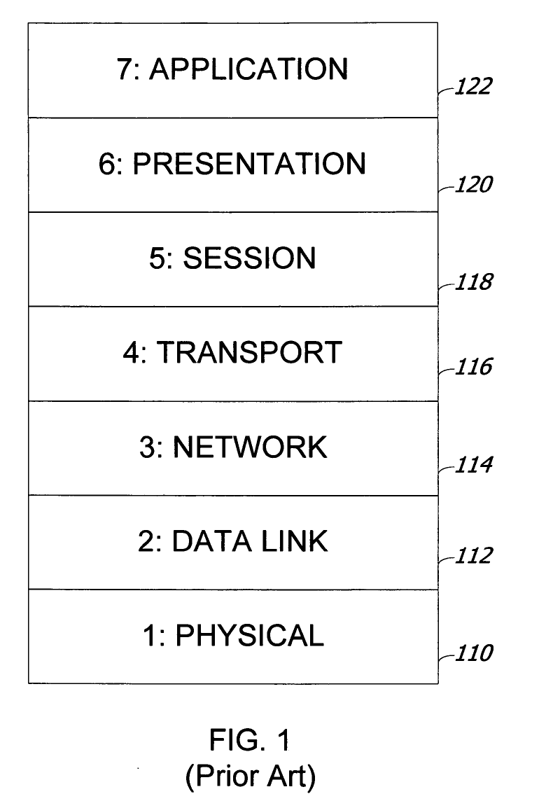

The present invention relies upon certain features of the Open System Interconnection (OSI) Reference Model, as standardized by the International Standards Organization (ISO), for describing how applications running on network-aware devices communicate with each other. The model, illustrated in FIG. 1, is commonly referred to as the OSI 7-layer model or the ISO 7-layer model. In FIG. 1, the first layer 220 is the Physical Layer, or Layer 1, which defines optical, electrical, and mechanical features of the physical means to interface between the network medium and network devices. One example of Layer 1 devices are the network interfaces behind connectors coupled to network interfaces controllers (NIC) using a copper-wire network medium. The second layer 112 in FIG. 1 is the Data Link layer, or Layer 2, which defines the procedures for operating communication links and access strategy for sharing the physical medium. Data link and media access issues are handled in Layer 2 for framing data packets and managing transmission errors. For the example of an Ethernet network, the physical address governing access is a six-byte Media Access Control (MAC) address that is unique to each NIC. Other devices which depend on Level 2 are bridges and switches, which are capable of adaptively learning which MAC addresses are attached to individual ports and storing a table of mapped network addresses to physical addresses. One example of a network address, also known as a Data Link Control (DLC) address, is a four-byte Internet address, or IP address. One example protocol for Layer 2 devices to learn the topology map of a network is the Address Resolution Protocol (ARP). The third layer 114 in FIG. 1 is the Network layer, or Layer 3, which determines how data is transmitted between network devices and provides a means to establish, maintain, and terminate network connections. One example of a Layer 3 device is a router. One example of a protocol in Layer 3 is the Internet Protocol, which routes packets according to unique network device addresses and provides flow and congestion control to ensure that network traffic flows smoothly. Higher level layers 116, 118, 120, and 122 in FIG. 1 correspond to the Transport, Session, Presentation, and Application layers, respectively and are referred to as Layer 4-7 respectively. The layers in FIG. 1 are often collectively referred to as a network stack; a Layer 7 application running on a device A can communicate on the network with an application running on device B through the stack. Each packet that is exchanged from A to B must first go through each layer down the stack from Layer 7 on device A, be physically transferred on Layer 1 from device A to B, and go up the stack to Layer 7 on device B. Such a network layering architecture is well known in the art.

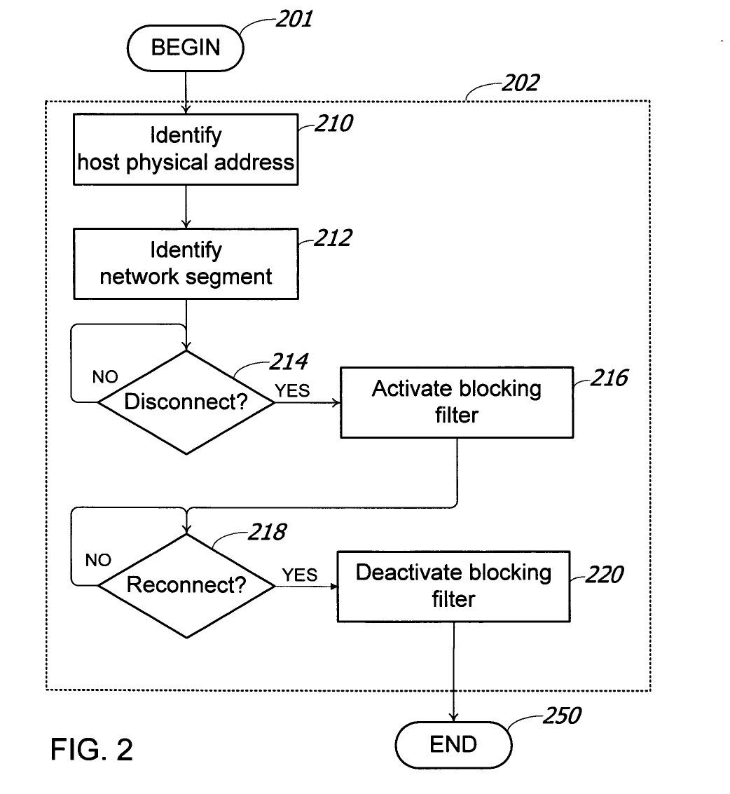

Referring to FIG. 2, an embodiment of the present invention that relies upon device functions in Layer 3 and Layer 2 of a network stack is illustrated. The process 202 comprises functions for logically disconnecting and reconnecting a given host computer. Note that embodiments of the process 202 may be operable on any type of network that provides Layer 2 and Layer 3 devices with physical and network addressing of host systems. The type of network may be a wired network using galvanic connectors, optical connectors, wireless transceivers, or any combination thereof.

The present invention may also be practiced in other embodiments with wireless communication networks, for the purpose of blocking a particular network device, in response to a malicious code attack or for another purpose of isolating a given network device or component. In the case of a wireless network, the physical address and network address may be substituted as required with other identifying information that serves to identify the unique network device and its logical network address. In one example, in a cellular wireless network for mobile voice communications, a unique hardware identifier, such as a device number associated with a cellular telephone device or the serial number of a SIM-card used to activate a cellular telephone device, may serve as the physical address, while the cellular phone number may serve as the network address. Such an arrangement would permit the blocking of a particular mobile telephone or a particular SIM-card. The ability to block a cellular phone independent of a particular SIM-card may be required for protecting a network from malicious code that may reside in the local memory of the mobile telephone. In one scenario, the present invention may be employed for protecting network devices from hybrid viruses that may crossover network systems and their end devices. In one embodiment of the present invention in a wireless communications network, a unique hardware identifier, such as a device number or MAC, associated with a wireless network interface may serve as the physical address, while the IP address of the wireless network interface may serve as the network address. In one example, a wireless device with both GSM and IEEE 802.11 capability may be disconnected from either network upon detection of a virus attack using the method of the present invention.

After begin 201, the initial step 210 of the process 202 in FIG. 2 comprises identifying the physical address of the network host for logical disconnection. In one example, a physical address may be a MAC address of the host NIC that serves to identify the host. In another case, a network address, such as an IP address, may be used to resolve the physical address of the network host.

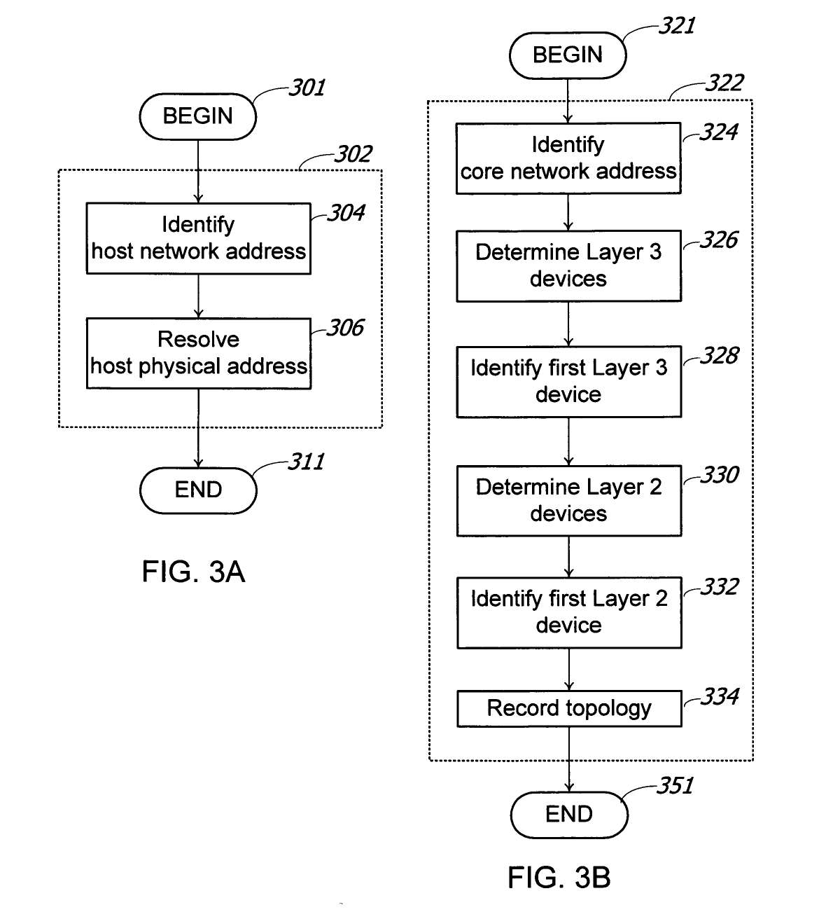

In FIG. 3A, an example of process 210 is illustrated in process 302. After begin 301, the first step 304 is to identify the network address of the host. In a second step, 306, the network address is used to resolve the physical address of the host. The step of identifying in steps 210, 304 may comprise input of the address information into a user interface in response to a prompt. Resolving the physical address 306 from secondary information, such as an IP address or other network identifier, may be performed automatically in response to a user input or performed manually. An automatic resolution may involve querying a network device that maintains an address resolution table to obtain a physical address back from the device. Manual resolution may involve issuing of commands using a network protocol to obtain the physical address. The process 302 terminates at step 311.

The next step 212 of process 202 in FIG. 2 involves identifying the network segment 212 where the network host is coupled to. In one embodiment of the present invention, a global address for interacting with all devices in the network segment is used. In another case, the effective network topology, comprising the communication path between the network core and the network host, is resolved.

In FIG. 3B, one embodiment for implementing the process 212 for identifying a network segment is illustrated as a separate process 322. The process 322 comprises a search for each Layer 2 and Layer 3 device to which the network host is coupled to. After begin 321, the first step 324 involves identifying the core network address. This requires that the network address of the network host be identified, which may occur via process 302 or by resolving the host network address from the physical address identified in 210. Once the host network address is known, the communication path of the host can be determined. This involves a search which begins at the core of the network. The term core in this sense refers to the center of an individually administered, autonomous network. In one example, such a network comprises a network domain administered by a domain server, which serves as the core. In step 326, the Layer 3 devices in the network are determined using a routing function. In one example, an ICMP trace route function is used to determine the each Layer 3 device on the network. Then in step 328, the first Layer 3 device that the network host is coupled to is identified. This Layer 3 device serves as the network router for the network host to be disconnected; blocking the path to this Layer 3 router, or gateway, serves to effectively disconnect the host from any further network connections. The process of identifying the network segment 322 further advances in step 330 by determining each Layer 2 device that is coupled to the first Layer 3 device identified in step 328. The step 330 begins by determining which physical interface the network host physical address is associated with on the first Layer 3 device. From there, each successive Layer 2 device between the first Layer 3 device and the network host is determined by querying the next directly coupled network device. Each step in the communication path, also known as a hop, may then be resolved. In one implementation, a protocol such as the Cisco Discovery Protocol (CDP) may be used to determine the next hop in the communication path. In one example, the interaction with network devices is performed using the Telnet protocol, once the communication patch and device addresses have been resolved. In step 332, the first Layer 2 device connected to the network host is determined. Since the previous steps have effectively resolved the network topology, in step 334 this information is recorded for future reference. In one example, the network topology is recorded in step 334 in a local database. The process 322 terminates at step 351.

The next step 214 in process 202 in FIG. 2 is the determination to logically disconnect the network host. This determination 214 may be made in response to a disconnect command, which may be issued manually or automatically. A manual disconnect command may be the result of a decision executed by operating a user-interface element by an administrator of the network. An automatic disconnect command may be issued in response to pre-defined criteria, such as, particular behavior or patterns of network traffic, installation maps of software versions on the network, or other criteria for determining if a particular host should be logically disconnected from the network. An automatic disconnect command may be accompanied by a notification to an administrator of the action taken with details of the network addresses and timestamp of the action. Until such time as a determination 214 is made to logically disconnect a given network host, the process 202 may stand idle or poll for a disconnect command to be issued. In response to a disconnect command, the process 202 activates a blocking filter 216 to logically disconnect a network host. There may be different implementations of the blocking filter. In one example method of applying the filter, network devices are instructed via Telnet to apply a MAC filter for blocking traffic from the network host being logically disconnected. In one embodiment of the blocking filter, the present invention applies a blocking filter on the first Layer 2 device that the network host is coupled to. In one embodiment of the blocking filter, the present invention applies a blocking filter to every Layer 2 device between the network host and the first Layer 3 device in the path to the network core, which effectively prevents the network host from being physically reconnected to the network. In one embodiment of the blocking filter, the present invention relies upon a network protocol to flood the network with instructions for forwarding devices to ignore transmissions for a given host, based on the host physical address. In one example implementation, messages similar to those used in the Simple Network Management Protocol (SNMP) are flooded through the network to activate MAC address filters on all network devices. After the blocking filter has been activated 216, the network host is considered logically disconnected from the network.

The next step of process 202 in FIG. 2 is the determination 218 if the network host should be logically reconnected to the network. This determination 218 may be made in response to a reconnect command, which may be issued manually or automatically. A manual reconnect command may be the result of a decision executed by operating a user-interface element by an administrator of the network. An automatic reconnect command may be issued in response to pre-defined criteria, such as if the host has been remediated, particular behavior or patterns of network traffic, installation maps of software versions on the network, or other criteria for determining if a particular host should be logically reconnected to the network. An automatic reconnect command may be accompanied by a notification to an administrator of the action taken with details of the network addresses and timestamp of the action. Until such time as a determination 218 is made to logically reconnect a given network host, the process 202 may stand idle or poll for a reconnect command to be issued. In response to a reconnect command, the process 202 deactivates a blocking filter 220 to logically reconnect a network host. There may be different implementations of the blocking filter, and thus, different implementations of removal of the blocking filter. In one example method of removing the filter, network devices are instructed via Telnet to remove a MAC filter so as to allow traffic from the network host being logically reconnected. In one embodiment of the blocking filter, the present invention removes a blocking filter on the first Layer 2 device that the network host is coupled to. In one embodiment of the blocking filter, the present invention removes a blocking filter from every Layer 2 device between the network host and the first Layer 3 device in the path to the network core. In one embodiment of the blocking filter, the present invention relies upon a network protocol to flood the network with instructions for forwarding devices to acknowledge and forward transmissions for a given host, based on the host physical address. In one example implementation, messages similar to those used in the Simple Network Management Protocol (SNMP) are flooded through the network to deactivate MAC address filters on all network devices. After the blocking filter has been deactivated 218, the network host is considered logically reconnected to the network, whereby the original state before logical disconnection in step 216 is obtained. The process 202 terminates at step 250.

Note that process 202 may be repeated, from begin 201 to end 250, or in part thereof, for a plurality of network hosts that require logical disconnection from a network, and subsequent reconnection. In one example, a plurality of network hosts may be sequentially suspended from network participation, and restored upon confirmation of individual remediation for each network host. In another example, a plurality of network hosts are both suspended and restored in a reentrant, simultaneous, or parallel manner.

The invention can take the form of an entirely hardware embodiment, an entirely software embodiment or an embodiment containing both hardware and software elements. In one embodiment, the invention is implemented in software, which includes but is not limited to firmware, resident software, microcode, etc. Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening VO controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

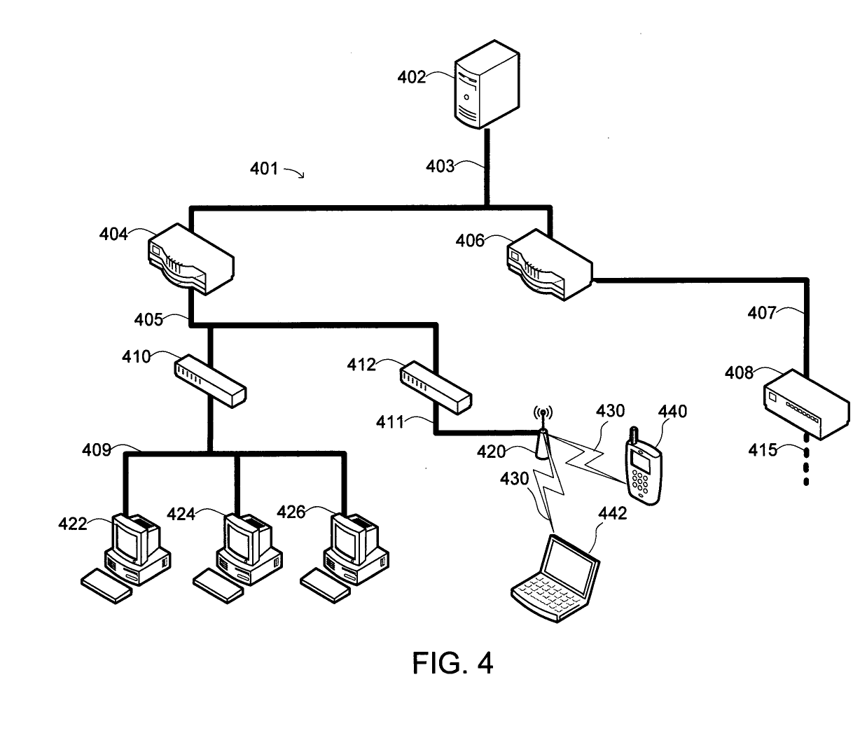

In FIG. 4 a network configuration 401 which may be used to practice one embodiment of the present invention is schematically represented. The network core is represented by server system 402, which can serve as the main server for a network domain represented by 401. The server may be equipped with a high-performance network interface 403 for connection to a plurality of Level 3 devices, such as routers 404 and 406. The router 406 may be connected via network interface 407 to bridge 408, which in turn, connects external network segment 415 (not shown in detail) to the present domain 401. In one example, external network segment 415 represents the Internet. The router 404 may be connected via a system of network connections 405, to a plurality of Level 2 devices, such as switches 410 and 412. Other Level 2 devices, such as wireless access point 420, may be connected via switches 410 and 412, or directly to router 404. In other examples, a hierarchical network of switches 410, 412 combined with hubs and repeaters (not shown), may be used to extend network access to a large number of client devices. Switch 410 is shown with an exemplary configuration connected via a system of network connections 409 to client computer systems 422, 424, 426. In one example, a single network host, such as system 426, is the object of the logical disconnection/reconnection of the present invention. The diagram in FIG. 4 is shown for illustrative purposes and does not limit the application or practice of the present invention in scope or complexity of any given embodiment of a network configuration. Network configurations with a large number of Layer 1, Layer 2, and Layer 3 devices represent typical environments for practicing the present invention.

The wireless network 430, provided by wireless access point 420, may serve communication device 440 or a client computer system 442. In one case, the present invention may be practiced with wireless network 430 to logically disconnect/reconnect either network host 442 or network host 440. The wireless communication device 440 may be equipped with an additional wireless interface, such as a cellular network interface. In one example, wireless access point 420 may represent a cell for providing wireless communications service to a large number of cellular devices, such as mobile telephones. In another case, wireless access point 420 may provide broadband wireless access over a wide-area. It is known in the art, for example, that networks conforming to the Global System for Mobile Communications (GSM) standard for wireless telecommunications may be modeled using the OSI-7 layer reference model. The present invention may be practiced with any such wireless network that conforms to or may be represented by the OSI-7 layer reference model.

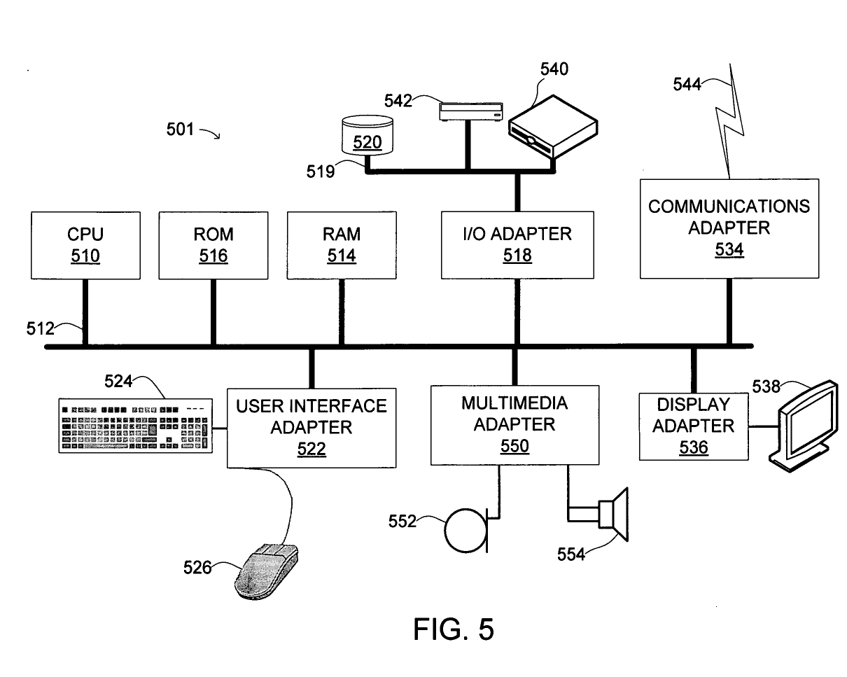

A system configuration of a typical network host computer system (such as items 422, 424, 426 in FIG. 4) is depicted in FIG. 5, which illustrates an exemplary hardware configuration of data processing system 501 having central processing unit (CPU) 510, such as a conventional microprocessor, and a number of other units interconnected via system bus 512. Data processing system 501 may include random access memory (RAM) 514, read only memory (ROM) 516, and input/output (I/O) adapter 518 for connecting peripheral devices. The peripheral devices to adapter 518 may be disk units 520, tape drives 540, optical drives 542 which are connected via peripheral bus 519 to bus 512. Data processing system 501 also may include user interface adapter 522 for connecting keyboard 524, mouse 526, and/or other user interface devices such as a touch screen device (not shown) to bus 512. Further included in system 501 may be communication adapter 534 for connecting data processing system 513 to a data processing network 544, and display adapter 536 for connecting bus 512 to display device 538. The data processing network 544 may be a wireless, galvanic wired, or optical media network with a star, ring, or other topology. In one example, a MAC address of communications adapter 534 represents the physical address of the network host, depicted as system 501. Further included in system 501 may be multimedia adapter 550 for connecting bus 512 to microphone 552 and loudspeaker system 554; other types of multimedia output and input devices, such as headphones and stereo speakers (not shown), may be used via analog or digital interfaces with adapter 550. CPU 510 may include other circuitry not shown herein, which will include circuitry commonly found within a microprocessor, e.g., execution unit, bus interface unit, arithmetic logic unit, etc.

Although the present invention and its advantages have been described in detail, it should be understood that various changes, substitutions and alterations can be made herein without departing from the spirit and scope of the invention as defined by the appended claims.

What is claimed is:

1. A method for suspending network traffic of a network host by controlling a logical network connection of said network host, comprising the steps of:
identifying a unique physical address of said network host;
identifying a network segment for applying a blocking filter for blocking network traffic associated with said physical address;
in response to a disconnect command, instructing network devices coupled to said network segment to activate said blocking filter for said physical address; and
in response to a reconnect command, instructing network devices coupled to said network segment to deactivate said blocking filter for said physical address.

2. The method as recited in claim 1, wherein the step of instructing network devices coupled to said network segment to activate said blocking filter for said physical address further comprises the step of instructing each device on the network to block all network traffic for said physical address; and wherein the step of instructing network devices coupled to said network segment to deactivate said blocking filter for said physical address further comprises the step of instructing each device on the network to transmit all network traffic for said physical address.

3. The method as recited in claim 1, wherein said network host comprises a wireless communications device and wherein said physical address uniquely identifies a wireless communications adapter.

4. The method as recited in claim 1, wherein the step of identifying a network segment for applying a blocking filter for blocking network traffic associated with said physical address further comprises determining a network communication path to said physical address, further comprising the steps of:
identifying a network address of the network core;
determining a network address of each Layer 3 device between said network core and said physical address;
identifying a first Layer 3 device physically coupled to said physical address;
determining a network address of each Layer 2 device coupled between said first Layer 3 device and said physical address;
identifying a first Layer 2 device physically coupled to said physical address; and
recording a network address of each Layer 3 and Layer 2 device along with a network connection topology.

5. The method as recited in claim 4, wherein the step of instructing network devices coupled to said network segment to activate said blocking filter for said physical address further comprises the step of instructing the first Layer 2 device physically connected to said physical address to block all network traffic for said physical address; and wherein the step of instructing network devices coupled to said network segment to deactivate said blocking filter for said physical address further comprises the step of instructing the first Layer 2 device physically connected to said physical address to transmit all network traffic for said physical address.

6. The method as recited in claim 4, wherein the step of instructing network devices coupled to said network segment to activate said blocking filter for said physical address further comprises the step of instructing each Layer 2 device between said first Layer 3 device and said physical address to block all network traffic for said physical address; and wherein the step of instructing network devices coupled to said network segment to deactivate said blocking filter for said physical address further comprises the step of instructing each Layer 2 device between said first Layer 3 device and said physical address to transmit all network traffic for said physical address.

7. A computer program product for suspending network traffic of a network host by controlling a logical network connection of said network host, comprising the programming steps of:
identifying a unique physical address of said network host;
identifying a network segment for applying a blocking filter for blocking network traffic associated with said physical address;
in response to a disconnect command, instructing network devices coupled to said network segment to activate said blocking filter for said physical address; and
in response to a reconnect command, instructing network devices coupled to said network segment to deactivate said blocking filter for said physical address.

8. The computer program product as recited in claim 7, wherein the programming step of instructing network devices coupled to said network segment to activate said blocking filter for said physical address further comprises the programming step of instructing each device on the network to block all network traffic for said physical address; and wherein the programming step of instructing network devices coupled to said network segment to deactivate said blocking filter for said physical address further comprises the programming step of instructing each device on the network to transmit all network traffic for said physical address.

9. The computer program product as recited in claim 7, wherein said network host comprises a wireless communications device and wherein said physical address uniquely identifies a wireless communications adapter.

10. The computer program product as recited in claim 7, wherein the programming step of identifying a network segment for applying a blocking filter for blocking network traffic associated with said physical address further comprises determining a network communication path to said physical address, further comprising the programming steps of:
identifying a network address of the network core;
determining a network address of each Layer 3 device between said network core and said physical address;
identifying a first Layer 3 device physically coupled to said physical address;
determining a network address of each Layer 2 device coupled between said first Layer 3 device and said physical address;
identifying a first Layer 2 device physically coupled to said physical address; and
recording a network address of each Layer 3 and Layer 2 device along with a network connection topology.

11. The computer program product as recited in claim 10, wherein the programming step of instructing network devices coupled to said network segment to activate said blocking filter for said physical address further comprises the programming step of instructing the first Layer 2 device physically connected to said physical address to block all network traffic for said physical address; and wherein the programming step of instructing network devices coupled to said network segment to deactivate said blocking filter for said physical address further comprises the programming step of instructing the first Layer 2 device physically connected to said physical address to transmit all network traffic for said physical address.

12. The computer program product as recited in claim 10, wherein the programming step of instructing network devices coupled to said network segment to activate said blocking filter for said physical address further comprises the programming step of instructing each Layer 2 device between said first Layer 3 device and said physical address to block all network traffic for said physical address; and wherein the programming step of instructing network devices coupled to said network segment to deactivate said blocking filter for said physical address further comprises the programming step of instructing each Layer 2 device between said first Layer 3 device and said physical address to transmit all network traffic for said physical address.

13. A system, comprising:
a processor;
a memory unit operable for storing a computer program for suspending network traffic of a network host by controlling the logical network connection of said network host;
a communications adapter;
a bus system coupling the processor to the memory and to the communications adapter, wherein the computer program is operable for performing the following programming steps:
identifying a unique physical address of said network host;
identifying a network segment for applying a blocking filter for blocking network traffic associated with said physical address;
in response to a disconnect command, instructing network devices coupled to said network segment to activate said blocking filter for said physical address; and
in response to a reconnect command, instructing network devices coupled to said network segment to deactivate said blocking filter for said physical address.

14. The system as recited in claim 13, wherein the programming step of instructing network devices coupled to said network segment to activate said blocking filter for said physical address further comprises the programming step of instructing each device on the network to block all network traffic for said physical address; and wherein the programming step of instructing network devices coupled to said network segment to deactivate said blocking filter for said physical address further comprises the programming step of instructing each device on the network to transmit all network traffic for said physical address.

15. The system as recited in claim 13, wherein said network host comprises a wireless communications device and wherein said physical address uniquely identifies a wireless communications adapter.

16. The system as recited in claim 13, wherein the programming step of identifying a network segment for applying a blocking filter for blocking network traffic associated with said physical address further comprises determining a network communication path to said physical address, further comprising the programming steps of:
identifying a network address of the network core;
determining a network address of each Layer 3 device between said network core and said physical address;
identifying a first Layer 3 device physically coupled to said physical address;
determining a network address of each Layer 2 device coupled between said first Layer 3 device and said physical address;
identifying a first Layer 2 device physically coupled to said physical address; and
recording a network address of each Layer 3 and Layer 2 device along with a network connection topology.

17. The system as recited in claim 13, wherein the programming step of instructing network devices coupled to said network segment to activate said blocking filter for said physical address further comprises the programming step of instructing the first Layer 2 device physically connected to said physical address to block all network traffic for said physical address; and wherein the programming step of instructing network devices coupled to said network segment to deactivate said blocking filter for said physical address further comprises the programming step of instructing the first Layer 2 device physically connected to said physical address to transmit all network traffic for said physical address.

18. The system as recited in claim 13, wherein the programming step of instructing network devices coupled to said network segment to activate said blocking filter for said physical address further comprises the programming step of instructing each Layer 2 device between said first Layer 3 device and said physical address to block all network traffic for said physical address; and wherein the programming step of instructing network devices coupled to said network segment to deactivate said blocking filter for said physical address further comprises the programming step of instructing each Layer 2 device between said first Layer 3 device and said physical address to transmit all network traffic for said physical address.
